(19) United States
(12) Patent Application Publication
(10) Pub. No.: US 2005/0286868 A1
(43) Pub. Date: Dec. 29, 2005

(54) Content recording, transfer, and compensation system

(76) Inventors: James P. Andrew, Dallas, TX (US); Carl H. Westcott, Dallas, TX (US)

Correspondence Address: MICHAEL A. O'NEIL, P.C., 5949 SHERRY LANE, SUITE 820, DALLAS, TX, 75225, US

(21) Appl. No.: 10/847,698

(22) Filed: May 18, 2004

Related U.S. Application Data
(60) Provisional application No. 60/472,095, filed on May 20, 2003.

(51) Int. Cl. H04N 5/76; H04N 5/781

(52) U.S. Cl. 386/94; 386/125

(57) ABSTRACT

A content recording system receives signals broadcast from one or more satellites and/or one or more land-based transmitters. The received content is initially recorded on a rolling recording medium. Upon actuation of a “BUY” button or switch information pertaining to the selected content is displayed. Upon a second actuation of a “BUY” button or switch the selected content is transferred from the rolling recording medium to a permanent recording medium. The system automatically compensates owners of copyrights in the selected content upon permanent recording thereof.

### CLAIM OF PRIORITY

This application claims priority of prior provisional Application Ser. No. 60/472,095 filed May 20, 2003, currently pending.

### TECHNICAL FIELD

This invention relates generally to the sale of content received via broadcast methods and formats and more particularly to a system for recording the entirety of a content item during receipt thereof, for selectively transferring the recorded content from a first temporary medium to any of a variety of additional media, for managing content or a collection thereof, for effecting compensation to sellers, including but not limited to owners of copyrights in the recorded content, and for limiting the distribution of content to purchasers.

### BACKGROUND AND SUMMARY OF THE INVENTION

In the past the recording of songs and other music, news broadcasts, talk shows and other content received by broadcast could only be accomplished by playing the content through one or more speakers and recording the output of the speakers utilizing one or more microphones. The recording of content received via broadcast utilizing the speaker/microphone technique includes numerous problems including but not limited to:
1. Extreme degradation of content quality;
2. Inability to start the recording at the beginning of the content if the broadcast of the content is already underway; and
3. Lack of a reasonable means for compensating owners of content for the recording thereof.

It is also known to directly record content received via broadcast methods and formats onto audio tapes, VCR tapes, CDs, DVDs, hard drives, etc. Although the quality of recordings made by direct recording, streaming or download techniques is substantially better than those made by the speaker/microphone technique, the problems enumerated in subparagraphs 2. and 3. above continue to exist.

It is also possible to record content available on the internet. However, currently available internet-based recording techniques introduce an additional problem of necessitating the ability to locate the desired content in order to record it. In order to address the desired content it is usually necessary to know the name of the song or other content to be recorded, or the name of the artist or other individual associated with the content, or the producer of the content, etc. In addition, difficulties arising from failure to compensate owners of copyrighted material that is recorded over the internet are well known.

Most recently it has become possible to purchase the right to download copyrighted material utilizing the facilities of the internet. This technique automatically compensates sellers and copyright owners for the use of the downloaded material thereby eliminating problems arising from failure to recognize the rights of copyright owners. However, it is still necessary to identify and address the content to be downloaded in order to use the internet downloading technique.

In those circumstances in which content is broadcast over the internet, it is not possible to purchase desired content immediately as indicated, but rather, requires re-direction on the internet to utilize internet downloading and commerce techniques to start the recording of the content at the beginning.

The present invention comprises a content recording, transfer, and compensation system which overcomes the foregoing and other problems which have long since characterized the prior art. In accordance with the broader aspects of the invention, content is received via a wide variety of broadcasts, including all suitably accommodative formats such as digital and internet radio and television; and all suitably accommodative means such as digital cable, digital satellite, digital AM and FM broadcasting such as the methods employed by Ibiquity® as example, Wi-Fi, Wider-Fi, Max-Fi, high definition broadcasting, digital UHF, digital VHF, etc.

All received saleable content is constantly, passively and temporarily recorded in a rolling memory, on any of a variety of media including various types of solid state recording media, various tape-type recording media, various computer-based recording media such as hard drives, thumb drives, etc. The invention contemplates the user-selective transfer of content from the temporary rolling memory to any of a variety of additional permanent or re-recordable media. Importantly, the invention contemplates the use of the aforementioned system to enable commerce - that is, the automatic compensation of copyright owners and other sellers for the recording of copyrighted material, while limiting distribution and management of content to purchasers.

Importantly, the use of a temporary rolling memory to record all saleable content allows the listener to decide to record a particular content item in its entirety, a song for example, after listening to a portion of it. The rolling memory also allows a listener to record the entirety of a desired song or other content item after the broadcast thereof has been completed, many songs later as an example.

In accordance with more specific aspects of the invention, when a user decides to purchase a particular song or other content, a “BUY” indication is made on or to the responsible hardware device. Actuation of the “BUY” process flow causes the hardware to use a facility to interpret or read information delivered as part of the discrete information packet that embodies a song or other content. Part of the “Price Tag” information is displayed for the user, including but not limited to the title or name of the song or other content, identification of the artist or other personality associated with the content, identification of the producer of the content, etc., as well as the price of the content.

If the listener elects to complete a purchase, that intent is so indicated by interaction with the hardware device, whereupon the components of the selected content packet requisite to identification, replay, preservation, expiry and security are transferred from the rolling memory to a permanent albeit re-recordable storage media. Simultaneously the components of the selected content packet are employed to enable the account of the user to be debited, while the account of the distributor of the media is credited for the purchase price and provided information associated with the user and the content.

Communication between the user's hardware and the facilities of the distributor or its agents shall be via any or multiple of many means, such as mobile telephony technologies, Wi-Fi, Wider-Fi, Max-Fi, satellite, etc. and completed with any frequency that suits the needs of all interested parties.

It is anticipated, but not requisite that a predetermined portion of the amount credited to the account of the distributor is designated as compensation for the owners of copyrighted material included in the recorded content. It is further anticipated that information collected about users and their purchases by aspects of the invention disclosed herein will be used by interested parties for marketing, research, planning and future creative purposes.

Once content is transferred to permanent (re-recordable) media it can be transported, equalized, sorted or otherwise manipulated by the purchaser at will. However, it is anticipated that known technologies will be employed to limit duplication in at least one foreseeable embodiment, while alternate means of protecting content owner's rights such as the limitation of content functionality to devices that contain a purchaser's identification information are also forseeable.

### DETAILED DESCRIPTION

A vehicle receives broadcast signals from one or more satellites and/or one or more land-based transmitters. The signals received from the satellites may include satellite radio, satellite televison, etc. The signals received from the land-based transmitters may include any signal capable of delivering complex information such Wi-Fi, Wider-Fi, Max-Fi, Digital FM, Digital AM, high definition television, or wireless internet embodiments, etc.

The vehicle has the system of the present invention installed therein. The system includes a delivery mechanism which in many instances will be installed in the dashboard of the vehicle. The delivery mechanism receives content which is broadcast from the satellites and/or from the land-based transmitters.

A listener situated within the vehicle listens to content which is received and reproduced by the delivery mechanism. When the listener desires to purchase a particular content item, a “BUY” button or switch is actuated. Upon initial actuation of the “BUY” button or switch the delivery mechanism displays appropriate “PRICE TAG” information on a display panel comprising part of the delivery mechanism.

The “PRICE TAG” includes some or all of: track price, track name, label name, artist name, track length in time, recording date, album or collection price, security information, anti-piracy information, commerce enabling information, video image(s) and ISRC code information that is decipherable and encode-able by software resident in or downloadable to the delivery mechanism. After considering the “PRICE TAG” information, the listener determines whether to continue the process for purchasing the selected content. This is accomplished by a second actuation of the “BUY” button or switch. The delivery mechanism then proceeds to complete the transaction with the royalty exchange and/or the listener's system internet interface as appropriate per the transaction type described hereinabove.

An important feature of the invention comprises the fact that the delivery mechanism includes a rolling recording media which initially records all discernable, saleable content received by the delivery mechanism. This allows the delivery mechanism to transfer a particular content item from the rolling recording media to a permanent albeit re-recordable recording medium even though the broadcast of the selected content item has already commenced, thereby selling a complete unit of content. Use of the rolling temporary recording medium also facilitates the transfer of a particular content item to the permanent recording medium even though broadcast of the selected content item has been previously completed, thereby enabling the sale of a desired yet not currently broadcast unit of content.

DELIVERY MECHANISM. Includes any device that enables the delivery of digital content, including content that at some point in the delivery or recording process was analog. Further, the DELIVERY MECHANISM has the ability to record content to a permanent, though potentially re-recordable memory facility that may be internal and/or a portable, detachable memory facility, such that the content is digital. The DELIVERY MECHANISM includes a facility to record content and discards content continuously while activated (rolling memory), facilitating spontaneous user selection of content underway, such that an entire content packet can be captured whether an intent to capture is indicated at the beginning, throughout the program to the end, and for a specified period after the end of the audible content delivery. Content packets may include songs, collections of songs, interviews, news programs or segments, talk programs or segments, commercials, movies and other video presentations, i.e., any content with an identifiable beginning and an end that is available for sale. Content as defined herein includes an electronic information component called a PRICE TAG that includes some or all of: track price, track name, label name, artist name, track length in time, recording date, album or collection price, secuirty features, constraint of use features, etc. and ISRC code information that is decipherable by software resident or downloadable to the DELIVERY MECHANISM. Upon an inquiry to purchase content the DELIVERY MECHANISM deciphers the appropriate PRICE TAG information for conveyance to the LISTENER. Upon a confirmed capture (purchase) of content, LISTENER's account identification information is encoded in the content, in the PRICE TAG or other facility programmable or populate-able by the DELIVERY MECHANISM, for the purpose of constraining use of the content to other devices included in the LISTENER's account. Information retrieved from the PRICE TAG is stored by the DELIVERY MECHANISM and uploaded upon demand to a remote device via Wi-Fi, telephony, etc. where the remote device can communicate with the DELIVERY MECHANISM—an addressable device.

For content purchased via the DELIVERY MECHANISM but not resident in a DELIVERY MECHANISM memory facility (a record album associated with a song in the DELIVERY MECHANISM'S memory facilities is an example) the specifications of the DELIVERY MECHANISM will give the LISTENER a choice to: have content delivered to a memory facility in or connected to the DELIVERY MECHANISM; to another named addressable device; to an email address or to the LISTENER'S SYSTEM INTERNET INTERFACE. To facilitate any remote transactions, the DELIVERY MECHANISM may include equipment designed to receive and/or send satellite, Wi-Fi, radio, internet, cable, infrared or other signals, or may be attached to such devices. The DELIVERY MECHANISM may include fast forward, rewind, pause, skip, search, random play and other features common to devices that facilitate content delivery, including the facility to extend retention of rolling memory to complete a requested task. The DELIVERY MECHANISM may include a back-up memory for purchased content, LISTENER's account information and other data, and may include other features, i.e. anti-theft technology, or other technology related or unrelated to the SYSTEM and/or any of its components. The DELIVERY MECHANISM may be an integrated component of another device, i.e. an automobile.

LISTENER. Includes any person actively or passively listening to content delivered by any means, where the Listener is not in control of the programming other than to activate the DELIVERY MECHANISM and/or choose a channel, station or other address where pre-organized content persists whether the Listener paticipates or not.

LISTENER'S SYSTEM INTERNET INTERFACE (LSII). Provides complete LISTENER account set-up and management facilties including but not limited to SYSTEM access control and contact facilities, DELIVERY MECHANISM add/delete/configuration, on-line bill payment, content re-equalization, re-compilation, master file storage management for a memory facility local to the internet access facility, i.e. a PC, portable device, other stationary device or a memory facility not local to the internet access facility, i.e. a location on the web. Facilities to convert, translate and/or transfer content among multiple, limited memory facilities identified with the LISTENER account.

ROYALTY EXCHANGE. Information per LISTENER account is collected via communication with the DELIVERY MECHANISM or the LSII. Information per LISTENER account includes but is not limited to: DELIVERY MECHANISM id, LSII id, date and time of a purchase, purchase id. information including all appropriate fields as identified in the PRICE TAG. Information is compiled into a billing statement and delivered to the account holder for payment. Royalty allocations are made from compiled PRICE TAG sales information and distributed electronically to accounts per record label, artist and/or the appropriate level of granularity. ROYALTY EXCHANGE is an automated electronic solution. Customer profile and sales data becomes re-saleable property.

The following steps further illustrate the present invention if the LISTENER develops an interest in owning content while it is being delivered:
1. LISTENER indicates a purchase interest by interacting with the DELIVERY MECHANISM.
2. The DELIVERY MECHANISM reads and returns PRICE TAG information for the content packet selected by LISTENER to a display for LISTENER'S consideration.
3. LISTENER interacts with the DELIVERY MECHANISM thereby confirming the purchase request.
4. The DELIVERY MECHANISM dedicates the selected content packet to the permanent (re-recordable) memory facility and provides confirmation to the LISTENER that the purchase was successful.

The following steps further illustrate the present invention if LISTENER develops an interest in owning content delivered prior to the most recent or current content being delivered:
5. LISTENER interacts with the DELIVERY MECHANISM indicating a request to search previously delivered saleable content.
6. DELIVERY MECHANISM displays rolling memory information for previously delivered, complete and saleable content packets.
7. LISTENER interacts with the DELIVERY MECHANISM to select content and indicate a purchase interest.
   a. Steps 2, 3, and 4 are repeated.
8. LISTENER interacts with the DELIVERY MECHANISM indicating interest in purchasing an entire album of music or other item beyond the content available in any of the DELIVERY MECHANISM'S memory facilities but associated with delivered content.
   a. Steps 2 and 3 are repeated.
9. DELIVERY MECHANISM requests content as required to fulfill the purchase request and directs content to the permanent memory location resident in the DELIVERY MECHANISM or to another named addressable device, an email address, or to the LISTENER'S SYSTEM INTERNET INTERFACE.
10. LISTENER indicates a preference to listen to one unit of purchased content, to listen to multiple units of purchased content in a specified or random order, or to replay any unit of content currently available from the rolling memory.
11. DELIVERY MECHANISM accesses and delivers content as requested from the appropriate memory facility, extending retention of the content selected from the rolling memory as required.
12. LISTENER removes portable, permanent, re-recordable memory facility to use content elsewhere.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. The content recording system comprising:
means for receiving broadcast content;
a rolling recording medium for temporarily recording a predetermined quantity of received content and for thereafter recording over previously recorded content;
a permanent recording medium for permanently recording content previously recorded by the rolling temporary recording medium; and
means for selectively transferred content from the rolling recording medium to the permanent recording medium; and
means for effecting compensation to owners of copyrights in the recorded content coincident with the transfer of the content from the rolling recording medium to the permanent recording medium.

2. The content recording system according to claim 1 wherein the content receiving means receives signals broadcast from one or more satellites.

3. The content recording system according to claim 1 wherein the receiving means receives content broadcast from one or more land-based transmitters.

4. The content recording system according to claim 1 wherein the receiving means, the rolling recording medium, the permanent recording medium, and the means for transferring recorded content from the rolling recording medium to the permanent recording medium are all mounted within a vehicle.

5. The content recording system according to claim 1 further including means for displaying information relating to selected content prior to the transfer of the selected content from the rolling recording medium to the permanent recording medium.
